(19) United States
(12) Patent Application Publication
(10) Pub. No.: US 2024/0001976 A1
(43) Pub. Date: Jan. 4, 2024

(54) METHOD AND APPARATUS FOR RECOGNITION OF OBSTACLES IN A DANGER ZONE, RAILROAD CROSSING, PLATFORM, COMPUTER PROGRAM PRODUCT AND PROVISION APPARATUS

(71) Applicant: Siemens Mobility GmbH, München (DE)

(72) Inventor: Jens Braband, Braunschweig (DE)

(21) Appl. No.: 18/343,963

(22) Filed: Jun. 29, 2023

(30) Foreign Application Priority Data
Jun. 29, 2022 (EP) 22181954.3

(51) Int. Cl. B61L 23/04; B61L 29/04; B61B 1/02; G06V 20/54

(52) U.S. Cl. CPC B61L 23/041; B61L 29/04; B61B 1/02; G06V 20/54

(57) ABSTRACT

A method for recognizing obstacles in a danger zone traversed by a vehicle using a sensor facility sensing an object. The sensed objects are recognized and assessed with computer assistance. A model containing objects to be recognized and their position at the danger zone is used for assessment of the objects. For recognized objects, a check uses the model if they are recognized at an expected position, until all objects of the model are assigned to a recognized object and the assessment is that no obstacle is in the danger zone, or an object is contained in the model, to which none of the recognized objects is assigned and the assessment is that an obstacle is in the danger zone. The object assessment is suspended while a vehicle traverses the danger zone. An arrangement for recognition of obstacles, railroad crossing, platform, computer program product and provision apparatus are also provided.

### CROSS-REFERENCE TO RELATED APPLICATION

This application claims the priority, under 35 U.S.C. § 119, of European Patent Application EP 22181954.3, filed Jun. 29, 2022; the prior application is herewith incorporated by reference in its entirety.

### FIELD AND BACKGROUND OF THE INVENTION

The invention relates to a method for recognition of obstacles in a danger zone, which is able to be traversed by a vehicle. Moreover, the invention relates to an arrangement for recognition of obstacles. Furthermore, the invention relates to a railroad crossing which has an arrangement for recognition of obstacles. Further, the invention relates to a platform which has an arrangement for recognition of obstacles. Lastly, the invention relates to a computer program product and also to a provision apparatus for the computer program product, wherein the computer program product is equipped with program instructions for carrying out this method.

Danger zones can be formed for example by railroad crossings or platforms. The danger zone in this case is the area of the track, which when traversed by a vehicle, i.e. the train, must be free from obstacles. Railroad crossings with (full) barriers are monitored by personnel or with comparatively expensive radar scanners, which need a safety approval (safety level SIL-3). For simpler operating circumstances solutions such as time-controlled closing after a warning signal (intercom cabinets according to DB RIL 456.0001) are allowed. Even for the supervision of platforms, at VAG Nuremberg for example, very expensive solutions with radar scanners are employed.

In the automobile industry there are widely used algorithms for obstacle recognition, which however are not yet employed in the open road environment, since in the past there have already been cases of failures with consequent accidents. Basically obstacles are recognized by objects in the area lying in front of the vehicle being recognized as such by using a suitable sensor system (optical sensors, radar, ultrasound) and classified with computer assistance preferably through the use of artificial intelligence. The result of the classification is the recognition of those objects that are to be assessed as an obstacle. An obstacle in this context is an object for which there is a danger of a collision with the vehicle concerned.

On the other hand objects can also be recognized that for example stand outside the path of the vehicle, whereby there is no danger of a collision. These are also not classified as an obstacle. In particular with railroad lines there is a plurality of objects that are at the edge of the line. Examples that can be given are signals, switches, track elements such as balises, overhead lines, tunnels, stations and the like. These may not be classified as an obstacle, since the vehicle must pass by them unhindered.

At present AI applications are not allowed to be used for safety applications (i.e. applications at a high safety level) in the rail area, in particular since their precise function can only be understood with difficulty and also the required distances that are necessary for a sensor system in the rail area cannot be covered. They can only be treated like a Black Box, which must be monitored with specific methods. This is a particular problem for the recognition of obstacles for automatic movement on the rails which must take place with a high level of safety. With the use of AI it cannot be predicted to what extent the sensor system can sense obstacles in the actual situation and whether it is capable of recognizing them at all, and it cannot be clearly established whether the danger zone on a line is free from obstacles.

Artificial intelligence (also abbreviated as AI below) within the framework of this invention is to be understood in the narrower sense as computer-assisted machine learning (also abbreviated as ML below). What is involved in this case is the statistical learning of the parameterization of algorithms, preferably for very complex application cases. Through the use of ML the system recognizes and learns, with the aid of previously input learning data, models and laws for the acquired process data. With the help of suitable algorithms self-contained solutions can be found by ML for problems that occur. ML is divided into three fields—supervised learning, unsupervised learning and reinforcement learning, with specific applications, for example regression and classification, structure recognition and prediction, sampling or autonomous action.

In supervised learning the system is trained by the relationship between input and associated output of known data and in this way approximately learns functional relationships. In this case this depends on the availability of suitable and sufficient data, since if the system is trained with unsuitable (for example non-representative) data, it learns incorrect functional relationships. In unsupervised learning the system is likewise trained with example data, but only with input data and without any relationship to a known output. It learns how data groups are to be formed and expanded, what is typical for the application case involved and where deviations or anomalies occur. This allows application cases to be described and error states to be discovered. In reinforcement learning the system learns through trial and error in that it proposes solutions to given problems and receives a positive or negative assessment of this proposal through a feedback function. Depending on the reward mechanism, the AI system learns to carry out corresponding functions.

Machine learning can be carried out by artificial neural networks (abbreviated as ANN), for example. Artificial neural networks are mostly based on the networking of many neurons, for example McCulloch-Pitts neurons or slight variations thereof. Basically other artificial neurons can also be used in ANNs, for example the high-order neuron. The topology of a network (the assignment of connections to nodes) must be determined as a function of its task. The construction of a network is followed by the training phase, in which the network “learns.” In such cases a network can learn for example by the following methods:
developing new connections
removing existing connections
changing the weighting (the weights of neuron j to neuron i)
adjusting the threshold values of the neurons, provided these possess threshold values
adding or deleting neurons
modification of activation, propagation or output function.

Moreover the learning behavior changes when the activation function of the neurons or the learning rate of the network changes. Seen in practical terms an ANN primarily learns by modification of the weights of the neurons. An adjustment of the threshold value in this case can also be handled by an on-neuron. ANNs are thereby capable of learning complicated non-linear functions through a learning algorithm, which by an iterative or recursive method of operation, attempts to determine all parameters of the function from available and desired initial functions. ANNs in this case are a realization of the connectionist paradigm, since the function include many simple parts of a similar type. Only in its sum does the behavior become complex.

### SUMMARY OF THE INVENTION

It is accordingly an object of the invention to provide a method and an apparatus for recognition of obstacles in a danger zone, in particular on a track traversed by a vehicle, a railroad crossing or a platform that can carry out such a method, a computer program product and a provision apparatus for the computer program product with which the method can be carried out, which overcome the hereinafore-mentioned disadvantages of the heretofore-known devices and methods of this general type and which run automatically and, under these circumstances, fulfill high safety requirements.

With the foregoing and other objects in view there is provided, in accordance with the invention, a method for recognition of obstacles in a danger zone, which is able to be traversed by a vehicle, in which a sensor facility senses objects lying in or on the danger zone, the sensed objects are recognized with computer assistance and for recognition of obstacles an assessment is made with computer assistance, in which for the assessment of the objects a model of the danger zone with the objects to be recognized is used, which contains a plurality of objects to be recognized and their position in or on the danger zone, wherein for the recognized objects, a check is made with the aid of the model as to whether these have been recognized at the expected position, until such time as either all objects of the model have been assigned to a recognized object, and the assessment is made that no obstacle is located in the danger zone, or an object is contained in the model to which none of the recognized objects has been assigned, and the assessment is made that an obstacle is located in the danger zone, wherein the assessment of the objects is suspended for as long as the vehicle is traversing the danger zone.

The inventive method for obstacle recognition thus reverses the known method for obstacle recognition. Normally the objects that could potentially represent an obstacle are recognized, wherein the aim of assessment is whether these objects actually represent an obstacle. In this case an uncertainty arises for the case that an object is not recognized and thus also when it represents an obstacle that no notice is taken of it. A potential danger lies herein for obstacle recognition in accordance with the prior art.

The objects that are to be recognized in accordance with the inventive method are those of which the positions are known as a result of the model of the danger zone (i.e. a description of the danger zone with the objects to be recognized, which make possible a comparison with the objects recognized and detected during the measurement by the sensor facility). Therefore for the case in which these are not recognized at the expected position, it can be concluded that they are covered by another unknown object. In this case an obstacle is probably involved, which is why the fact that an object cannot be recognized can be used to initiate a safety measure, for example emergency braking.

This method has the advantage that previously known objects have to be recognized exclusively. This is able to be brought about with a greater degree of safety than recognizing the obstacles themselves, of which the shape and positioning on or at the track is only known when these are recognized as such. A further advantage, for the case in which an object would have been to be recognized in accordance with the inventive method but was not recognized, includes a safety measure being initiated, which would not have been necessary. An error in the recognition of the objects thus does not lead to an accident, but to an unfounded safety measure. The consequences of such a wrong assessment are therefore advantageously far less than if an accident would have been caused. This shows that the inventive method can be operated with a high level of safety even in the event of an error.

The inventive concept of assisting the AI by a model of the danger zone is used in accordance with the invention for a line free message, in particular danger zone free message, i.e. explicit zones within the safety distance in front of the vehicle are to be identified, in which no obstacle can be located, because all objects present in the danger zone according to expectations (defined by the model) have been recognized.

In formation of the model for the obstacle recognition at least one part of the following assumptions is considered (more about this below):
there are known objects in the environment of the danger zone of which the shape is known. This could be a signal for example, or signs or other markers. These can possess further characteristics such as for example color of the sign, symbols on the sign, reflection capability (for light or radar beams).
the objects are entered in a model (for example through a vector at the foot point of the danger zone), preferably unique relative to track forming the line section on which the vehicle is travelling.
one or more sensors in or on the danger zone sense the environment.
an AI algorithm recognizes the objects and extracts the desired characteristics of the objects, in particular their outline, where necessary cleansed of overlaps or disruptions.
a secure process then makes decisions, for example the activation of or request for braking of an approaching vehicle (in particular of a train) for emergency braking.

The model is distinguished in that it maps or describes objects to be recognized in relation to their position on the line in or on the danger zone. Various formats can be selected for this purpose.

The model can be embodied two-dimensionally. In this case the extent of the danger zone on the surface of the earth can be taken into account. This involves a two-dimensional projection. The extent of the model can also be mapped three-dimensionally in the model. In this case the position of the objects to be recognized can also be defined in respect of their height above the track. The three-dimensional model can in particular be mapped as virtual reality.

Virtual reality, (abbreviated as VR below), refers to the presentation of the reality (also referred to as physical reality) in a real-time, computer-generated, interactive virtual environment. The level of detail in which the VR must be created depends on the individual application case. In general the VR is created in a three-dimensional space and maps its physical characteristics, in particular topography, in a simplified manner.

Knowledge of the location and the direction of view of the observer, i.e. in this case of the sensor facility for sensing the objects, are prerequisites for the application of a VR. If a VR is used for rail traffic certain simplifications are produced in this case.

Advantageously a solution is presented that manages without additional safety technology (except for commercial sensors and monitoring mechanisms) and which, despite this, makes a reliable recognition of objects or obstacles possible. In this case inventive use is made of the fact that stationary scenarios are involved, but for which possibly environmental conditions change such as weather, time of day etc. It has been shown that very reliable results are obtained with commercial sensors such as cameras, lidar, radar etc. in combination with model recognition, but this is difficult to verify, since for example machine learning methods (ML) for example neural networks (NN) are difficult to explain. This applies in particular when the environmental conditions can change.

Therefore ML methods must be assisted in order to achieve verifiable results. There is therefore provision in accordance with the invention for a fixed area to be monitored, but one of which the “image” can change depending on the environmental state. I.e. for a fixed environmental state the “normal” images are very similar and foreign objects should be better able to be recognized than without additional information. In particular the absence of objects is simple to detect in accordance with the invention by the fact that known objects can be more easily recognized, i.e. there is no occlusion by obstacles or the like.

“Processor-assisted” or “computer-implemented,” in the context of the invention can be understood as an implementation of the method in which at least one computer or processor carries out at least one method step of the method.

The term “processor” or “computer” covers all electronic devices with data processing characteristics. Computers can for example be personal computers, servers, handheld computers, mobile radio devices and other communication devices that process data with computer assistance, processors and other electronic devices for data processing, which can preferably also be connected together into a network.

A “processor” in the context of the invention can for example be understood as a converter, a sensor for creation of measurement signals or an electronic circuit. A processor can in particular involve a Central Processing Unit (CPU), a microprocessor, a microcontroller, or a digital signal processor, possibly in combination with a memory unit for storage of program instructions, etc. A processor can also be understood as a virtualized processor or a soft CPU.

A “memory unit” in the context of the invention can for example be understood as a computer-readable memory in the form of a Random-Access Memory (RAM) or data memory (hard disk or data medium).

“Interfaces” can be realized as hardware, for example hard-wired or as a radio link, and/or software, for example as interaction between individual program modules or program parts of one or more computer programs.

A “Cloud” is to be understood as an environment for “Cloud computing”. This means that an IT infrastructure that is made available through interfaces of a network such as the Internet. As a rule it contains storage space, computing power or software as a service, without these having to be installed on the local computer using the Cloud. The services offered within the framework of Cloud computing include the entire spectrum of information technology and include inter alia infrastructure, platforms and software.

“Program modules” are to be understood as individual functional units that make an inventive program execution of method steps possible. These functional units can be realized in a single computer program or in a number of computer programs communicating with one another. The interfaces realized in this case can be implemented as software with a single processor or as hardware when a number of processors are used.

According to one embodiment of the invention there is provision for markers that bear information for the recognition of the objects to be detected as objects.

This measure is advantageous in particular when not enough objects are present in the danger zone to be able to contribute to a seamless obstacle recognition. In this case additional markers can be provided, which have the detection as an object as the main function. At the same time the traffic signs can also contain an encoding with which additional information can be detected. This can involve location coordinates for example.

It can in particular prove advantageous to place specific signs, for example signs standing low down, in order to cover the foot of the danger zone. These can be taken into consideration even during project planning, in order for example to exclude specific obstacles close to the ground in the danger zone.

In accordance with one embodiment of the invention there is provision, after the assessment is made that an obstacle is located in the danger zone, for the sensor facility to sense the obstacle lying in the danger zone and for the detected obstacle to be recognized with computer assistance.

In other words for the case in which the presence of an obstacle has been recognized, an obstacle recognition is carried out in the sense that is known per se in the prior art. By comparison with the method in accordance with the prior art however it is already known at this point in time that an obstacle is located on the track section. Safety measures can therefore already be initiated. The recognition of the obstacle as such, in particular the recognition of the type of obstacle can however yield addition information, which can influence the decision about how the safety measure is to be carried out (this has already been discussed).

In accordance with one embodiment of the invention there is provision for the danger zone of a railroad crossing to be monitored.

This will be clarified below using the example of the danger zone at a railroad crossing. The danger zones of railroad crossings include railroad tracks located between the barriers that are to be traversed by the approaching vehicle. Therefore no obstacles may remain in this zone, for example pedestrians or motor vehicles, that are crossing the track section and are trapped between the barriers.

In accordance with one embodiment of the invention there is provision for the sensor facility to be attached to at least one barrier tree or at least one barrier drive of the railroad crossing and to monitor the danger zone in a direction of view facing towards the track.

One or more cameras are installed on the barrier drive and also on the barrier itself (aligned to the danger zone itself or the opposite barrier). At the same time optically easily recognizable markers are attached to the barrier tree, for example reflecting, fluorescent, with a characteristic shape etc. For this hanging grids can especially also be used, which bring an improved coverage of the zone. For danger zones not covered recognition can be on the other side of the marker involved and the marker can be recognized with machine learning methods for example. If both sides recognize the marker sufficiently well (for example depending on the size of the minimum test body that has to be recognized), then the danger zone can be signaled as free.

In accordance with one embodiment of the invention there is provision for the danger zone of a platform to be monitored.

With platforms the danger exists that passengers or objects such as items of baggage fall from the platform onto the track. In this case safety measures must be initiated, for example a vehicle traveling into the station must be slowed down or even stopped.

With platforms, in particular in local transit with metros, or with low safety requirements, the arrangement can also be carried out on one side, for example cameras only on the one side, for example below the platform, and the model only on the other side.

In accordance with one embodiment of the invention there is provision for the sensor facility to be attached on or below a platform edge on the platform or lying opposite the platform and for the danger zone to be monitored in the direction of view towards the track.

In accordance with the invention, there is alternatively provided an arrangement specified at the outset, in which the arrangement is configured to carry out the method according to the invention.

The stated object is alternatively achieved with a railroad crossing and also a platform specified at the outset in accordance with invention, by the arrangement being configured to carry out the method according to the invention.

With the arrangement, the railroad crossing and the platform, the advantages can be achieved that have already been explained in conjunction with the method described in greater detail above. What has been stated for the inventive method also applies accordingly for these inventive apparatuses.

With the objects of the invention in view, there is also provided a non-transitory computer program product with program instructions for carrying out the inventive method and/or its exemplary embodiments, wherein through the use of the computer program product the inventive method and/or its exemplary embodiments are able to be carried out in each case. The computer program product comprises program instructions that, when the program is executed by a computer, cause the computer to carry out the method or at least computer-implemented steps of the method.

With the objects of the invention in view, above and beyond this, there is concomitantly provided a provision apparatus for storing and/or providing the computer program product, in particular a computer-readable memory medium, on which the computer program product is stored. The provision apparatus is for example a memory unit, which stores and/or provides the computer program product. As an alternative and/or in addition the provision apparatus is for example a network service, a computer system, a server system, in particular a distributed, for example Cloud-based, computer system and/or virtual processor system, which stores and/or provides the computer program product preferably in the form of a data stream.

The provision takes place in the form of a program data block as a file, in particular as a download file, or as a data stream, in particular as a download data stream, of the computer program product. This provision can for example also take place as a partial download however, which includes of a number of parts. Such a computer program product is for example read into a system using the provision apparatus, so that the inventive method is carried out on a computer.

Further details of the invention are described below with the aid of the drawing. Elements of the drawing that are the same or correspond to one another are labeled with the same reference characters in each case and are only explained more than once when there are differences between the individual figures.

The exemplary embodiments explained below involve preferred forms of embodiment of the invention. In the exemplary embodiments the described components of the forms of embodiment each represent individual features of the invention to be considered separately from one another, which also develop the invention separately from one another and are thus to be seen, individually or in a combination other than that shown, as an element of the invention. Furthermore the described components are also able to be combined by the features of the invention described above.

Other features which are considered as characteristic for the invention are set forth in the appended claims.

Although the invention is illustrated and described herein as embodied in a method and an apparatus for recognition of obstacles in a danger zone, a railroad crossing, a platform, a computer program product and a provision apparatus, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, perspective view of an exemplary embodiment of the inventive apparatus as a railroad crossing with its working interrelationships;

FIG. 2 is a perspective view of an exemplary embodiment of the inventive apparatus as a platform with its working interrelationships;

FIG. 3 is a block diagram of an exemplary embodiment of a computer infrastructure of the apparatus in accordance with FIG. 1, wherein the individual functional units execute program modules, which can each run in one or more processors and wherein the interfaces can accordingly be configured in software or in hardware; and

FIG. 4 is a flow diagram of an exemplary embodiment of the inventive method, wherein the individual method steps can be realized singly or in groups by program modules and wherein the functional units and interfaces in accordance with FIG. 2 are indicated by way of example.

### DETAILED DESCRIPTION OF THE INVENTION

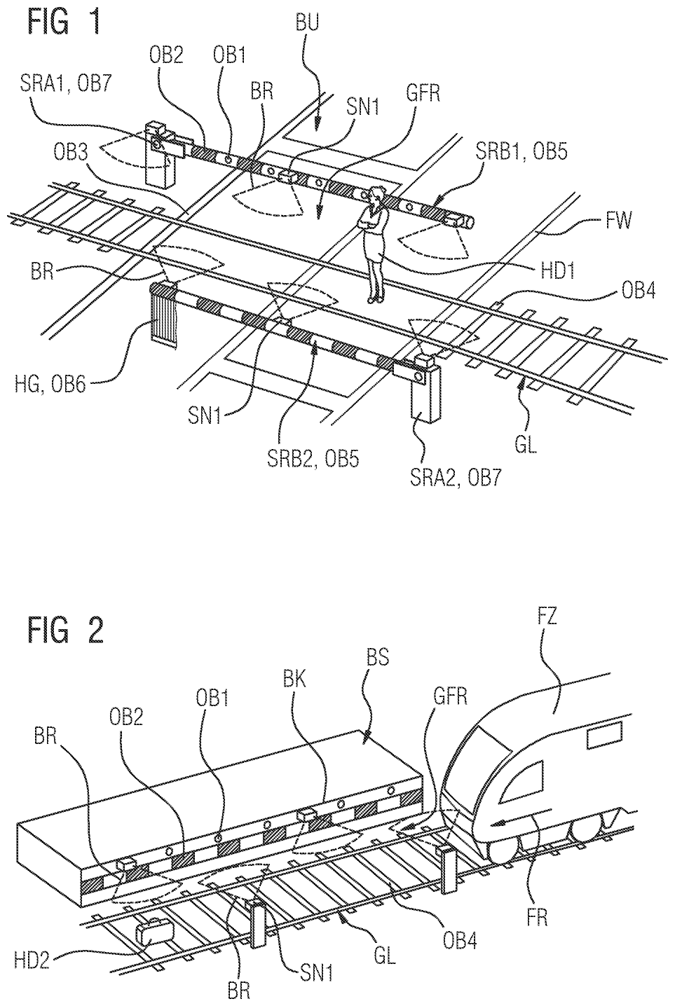

Referring now to the figures of the drawings in detail and first, particularly, to FIG. 1 thereof, there is seen a railroad crossing BU. The railroad crossing BU has two barriers, which each include a barrier drive SRA1, SRA2 and a barrier tree SRB1, SRB2. The railroad crossing BU is formed by a track GL, which crosses a highway FW. A danger zone GFR is therefore formed between the barrier trees SRB1, SRB2 that is to be checked for the presence of obstacles HD1. In the exemplary embodiment in accordance with FIG. 1, the danger zone GFR is to be checked for a person.

For the purposes of checking, sensors SN1 in the form of cameras, are attached to the barrier drives SRA1, SRA2 and also to the barrier trees SRB1, SRB2, which are aligned in a direction of view BR, indicated by an aperture angle to the danger zone GFR. In particular the sensors SN1, by overlapping of the aperture angles, can create a contiguous image of the barrier lying opposite in each case.

In order to monitor the danger zone GFR for obstacles HD1, the inventive method makes provision for the images to be assessed in a computer not shown in the figure (more about this below). An approach that is adopted in this case is that in the images, various objects OB1 . . . OB7, which must be recognized in the images, are stored as a model. In this way the entire railroad crossing can be present for example as virtual reality or also two-dimensionally, for example as a number of stored images. While there is no obstacle HD1 in the danger zone GFR, all objects OB1 . . . OB7 must accordingly be recognized and a danger zone free message is generated. If not all objects OB1 . . . OB7, which are stored in the model are recognized, a message is generated that an obstacle has been established in the danger zone GFR.

The reference characters OB1 . . . OB7 designate particular types of objects, which will be briefly explained below. The object OB1 involves a reflector, which in particular for optical monitoring generates a strong signal by reflecting light. If radar is used as a sensor SN1, then the object OB1 can also involve a reflector for radar waves. The object OB2 is a colored marking on the barrier tree SRB1, as is usually attached to it. These can also be easily recognized on an image. The object OB3 is a colored identifier on the highway FW, in the exemplary embodiment in accordance with FIG. 1 between the rails of the track GL. This can also be easily monitored in order in particular to detect small obstacles, since the obstacles cover a part of the subsurface formed by the highway FW. Object OB4 involves the cross ties. These can in particular be monitored optically in the edge area of the railroad crossing, i.e. before and after the highway FW. The barrier tree SRB1 forms an object OB5, which is able to be recognized on the image. A hanging grid HG, which can hang down from the barrier trees SRB1, SRB2, is to be detected as an object OB6 and is only indicated in FIG. 1. Lastly the barrier drive SRA1 also produces an object OB7, which may not be hidden.

It can be seen that both elements of the railroad crossings that have to be provided as part of their construction, such as barrier drives SRA1, SRA2, rail ties, etc. are used in the model, as well as specific markings OB1, OB2, OB3, which are provided as extras for an image recognition in the railroad crossing and to this extent are used as markers.

FIG. 2 shows a platform BS having a platform edge BK facing the track GL, on which a danger zone GFR arises. In order to monitor the zone a similar arrangement is set up to the one described in FIG. 1. A check is carried out by using the sensors SN1, which are each aligned in a direction of view away from the platform edge BK or towards the platform edge BK, so that when a vehicle FZ is approaching in the direction of travel FR no obstacles HD2 (an item of luggage in FIG. 2) are present. In this example, similar objects OB1 are stored as reflectors, OB2 as colored markings, OB4 as rail ties, etc. in a model and their presence is checked in the sensor results.

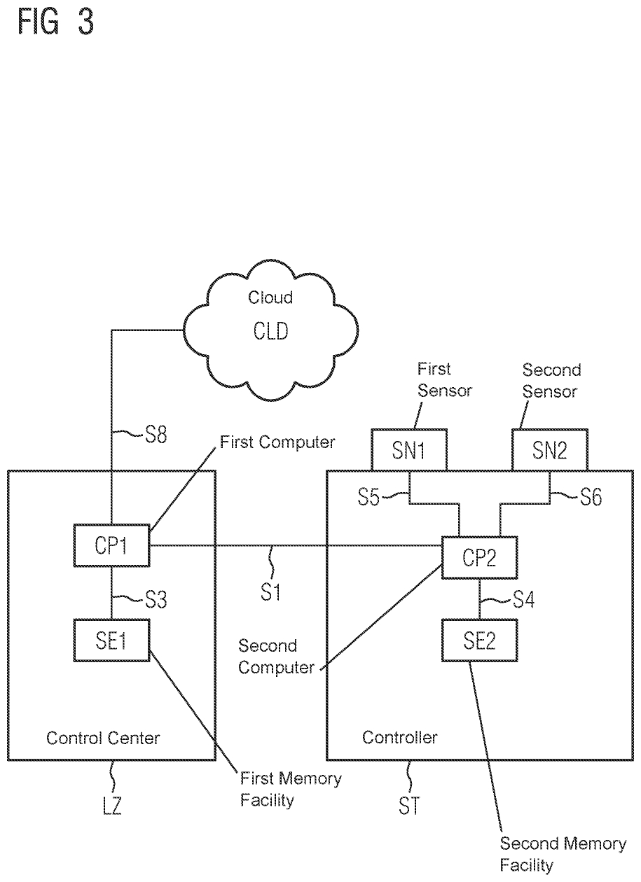

FIG. 3 shows a computer infrastructure that is suitable for carrying out the inventive method. Program modules can be processed in this case by a first computer CP1 in a control center LZ, by a second computer CP2 in a controller ST for the railroad crossing BU or for a platform BS and within a Cloud CLD.

The control center LZ includes the first computer CP1, which is connected through a third interface S3 to a first memory facility SE1. Moreover the first computer CP1 is connected through an eighth interface S8 to the Cloud CLD. Moreover the first computer CP1 is connected through a first interface S1 to the second computer CP2 of the controller ST.

The second computer CP2 has a fourth interface S4 to a second memory facility SE2. The controller moreover has a first sensor SN1, for example a camera, and optionally a second sensor SN2, for example a radar. The sensor data of the first sensor SN1 is transmitted through a fifth interface S5 and the sensor data of the second sensor SN2 through a sixth interface S6, to the second computer CP2.

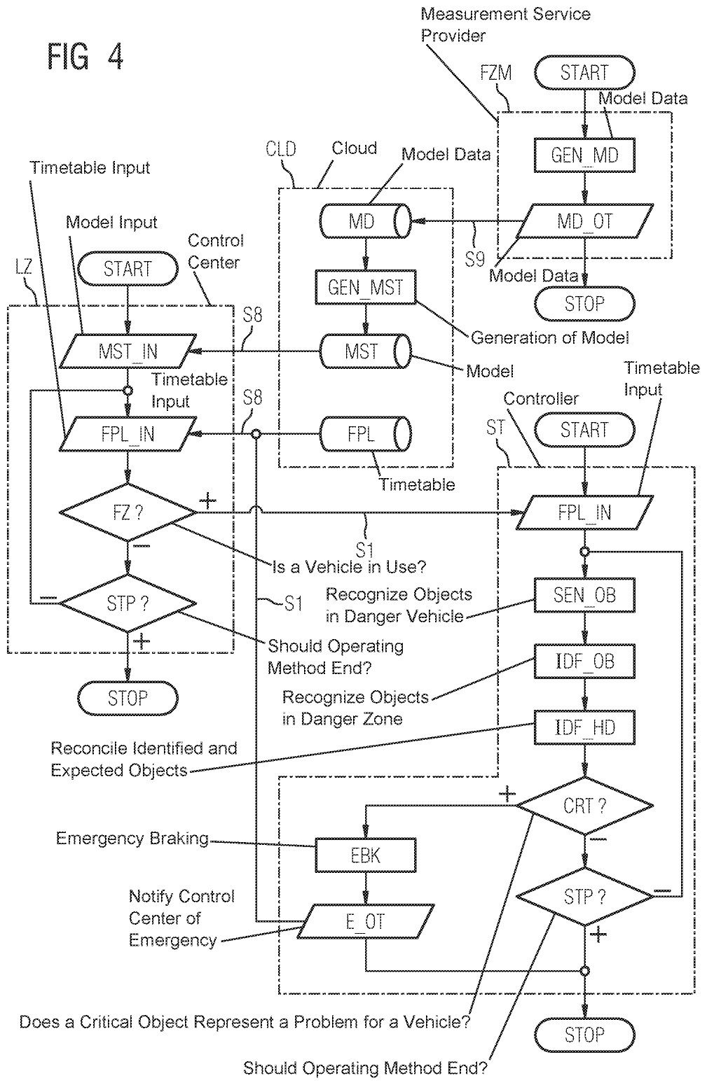

FIG. 4 shows an exemplary embodiment for execution of the inventive method, supplemented by a few preparatory execution steps. Shown in this figure is the Cloud CLD, which makes available a service for creation of a model. For this purpose a measurement and where necessary a marking (cf. FIGS. 1 and 2) of the danger zone is carried out by a measurement service provider FZM, in which, after the method is started, model data is generated in a generation step for model data GEN_MD, which for example involve the digital images of the danger zone. This can be transmitted in an output step for model data MD_OT through an interface S9 to the Cloud CLD and stored there. Furthermore a service provider, not shown in any greater detail, is connected to the Cloud CLD, which, in a generation step for the model GEN_MST creates a model MST. This can in particular be formed of a virtual reality VR, i.e. a three-dimensional representation of the environment of the danger zone. As an alternative it is possible to select a two-dimensional representation. The model MST is stored in the Cloud CLD.

After the method has been started in the control center LZ, the model MST is made available through the eighth interface S8 in an input step for the model MST_IN. Moreover in an input step for a timetable FPL_IN likewise through the eighth interface S8, a timetable FPL for vehicles is loaded from the Cloud CLD.

In a subsequent interrogation step FZ?, it is clarified whether a vehicle is in use. If this is not the case, it is queried in an interrogation step for the end of the method STP? whether the operating method is to be ended in the control center LZ. If this is the case the method is stopped. If this is not the case, then in a further input step FPL_IN, a renewal of the timetable data is undertaken and the method begins again.

When the vehicle FZ has been started, the interrogation step FZ? leads to it being confirmed to the control center LZ that a vehicle is in use, so that the model can be read in through the first interface S1 in an input step for the timetable FPL_IN. Subsequently, a sensing step for objects SEN_OB is undertaken in the vehicle, in which sensor data is generated for recognition of objects. In a subsequent identification step for objects IDF_OB the sensor data is processed to the extent that objects OB lying in or on the danger zone are recognized.

In a subsequent identification step for obstacles IDF_HD, a reconciliation of objects found in the preceding identification step for objects IDF_OB with the objects to be expected as a result of an assessment of the model is carried out. An obstacle is identified when an object which would be expected to be recognized due to the knowledge or the model cannot be recognized in the field of view BF of the sensor SN1 . . . SN2.

If an obstacle was recognized, a check is made in an interrogation step for critical obstacles CRT? as to whether the obstacle represents a problem for the approaching vehicle. This is the case in particular when it exceeds a specific size. If the obstacle is not critical, it is established in an interrogation step for the end of the method whether the operation of the vehicle FZ has been ended. If this is the case the method is stopped. If this is not the case, the execution of the method depicted begins again with the sensing step for objects SEN_OB.

If a critical obstacle is involved, in a next step an emergency braking EBK of the approaching vehicle is initiated. This can also be undertaken, in a way not shown, by the control center LZ and not handled by the controller ST. Subsequently, in an output step for the emergency E_OT there is a notification to the control center LZ through the first interface S1, which subsequently makes an appropriate change to the timetable (merely indicated in FIG. 4). In any event the method of the controller is also stopped after the emergency braking EBK.

The following is a summary list of reference numerals and the corresponding structure used in the above description of the invention.

### LIST OF REFERENCE CHARACTERS

LZ Control center
BU Railroad crossing
BS Platform
GFR Danger zone
FZ Vehicle
FZM Measurement service provider
FR Direction of travel
BR Direction of view
GL Track
FW Highway
HD1 . . . HD2 Obstacle
OB1 . . . OB7 Object
MST Model
SRB1 . . . SRB2 Barrier tree
SRA1 . . . SRA2 Barrier drive
HG Hanging grid
BK Platform edge
CP1 . . . CP2 Computer
SE1 . . . SE2 Memory facility
SN1 . . . SN2 Sensor
S1 . . . S Interface
CLD
GPS
Cloud
Global Positioning System module
MST Model
MD Model data
GEN_MD Generation step for model data
MD_OT Output step for model data
MST_MST Generation step for model
MST_IN Input step for model
FPL_IN Input step for timetable
SEN_OB Sensing step for objects
IDF_OB Identification step for objects
IDF_HD Identification step for obstacles
CRT? Interrogation step for critical obstacle
EBK Emergency braking
STP? Interrogation step for end of method
FZ? Interrogation step for vehicle in use
E_OT Output step for emergency

1. A method for recognition of obstacles in a danger zone able to be traversed by a vehicle, the method comprising:
using a sensor facility to sense objects lying in or on the danger zone;
recognizing the sensed objects with computer assistance;
carrying out an assessment with computer assistance for recognition of obstacles;
using a model of the danger zone with the objects to be recognized for the assessment of the objects, the model containing a multiplicity of objects to be recognized and a position of the objects in or on the danger zone;
checking, aided by the model, whether the recognized objects have been recognized at an expected position, until:
all of the objects of the model have been assigned to a recognized object and the assessment reveals no obstacle located in the danger zone, or
the model contains an object not assigned to any of the recognized objects and the assessment reveals an obstacle located in the danger zone; and
suspending the assessment of the objects while the vehicle passes through the danger zone.

2. The method according to claim 1, which further comprises sensing markers as objects, the markers carrying information for the sensing of the objects.

3. The method according to claim 1, which further comprises, after the assessment that an obstacle is located in the danger zone:
using the sensor facility to sense the obstacle lying in the danger zone; and
recognizing the sensed obstacle with computer assistance.

4. The method according to claim 1, which further comprises monitoring a danger zone of a railroad crossing as the danger zone.

5. The method according to claim 4, which further comprises attaching the sensor facility to at least one barrier tree or at least one barrier drive of the railroad crossing, and using the sensor facility to monitor the danger zone in a direction of view towards a track.

6. The method according to claim 1, which further comprises monitoring a danger zone of a platform as the danger zone.

7. The method according to claim 6, which further comprises attaching the sensor facility to the platform at or below a platform edge or lying opposite the platform, and using the sensor facility to monitor the danger zone in a direction of view towards a track.

8. An arrangement for recognition of obstacles, the arrangement comprising:
a sensor facility for sensing objects in a danger zone; and
a computer for recognition of the sensed objects;
said arrangement configured to carry out the method according to claim 1.

9. A railroad crossing, comprising:
an arrangement for recognition of obstacles, the arrangement including:
a sensor facility for sensing objects in a danger zone of the railroad crossing; and
a computer for recognition of the sensed objects;
said arrangement configured to carry out the method according to claim 1.

10. A platform, comprising:
an arrangement for recognition of obstacles, the arrangement including:
a sensor facility for sensing objects in a danger zone in front of the platform; and
a computer for recognition of the sensed objects;
said arrangement configured to carry out the method according to claim 1.

11. A non-transitory program product, comprising program instructions stored thereon, that when executed on a processor, carry out the method according to claim 1.

12. A provision apparatus for the computer program product according to claim 11, the provision apparatus at least one of storing or providing the computer program product.
